(19) United States
(12) Patent Application Publication
(10) Pub. No.: US 2022/0361509 A1
(43) Pub. Date: Nov. 17, 2022

(54) GLUTEN-FREE FLEXIBLE VEGETABLE HASH-BASED FOOD PRODUCT

(71) Applicant: Lamb Weston, Inc., Eagle, ID (US)

(72) Inventor: Luz Daniela Bermudez-Aguirre, Richland, WA (US)

(21) Appl. No.: 17/744,200

(22) Filed: May 13, 2022

Related U.S. Application Data
(60) Provisional application No. 63/189,365, filed on May 17, 2021.

(51) Int. Cl. A21D 2/36; A21D 13/066; A21D 13/045; A21D 15/02; A21D 17/00; A21D 2/18; A21D 2/26

(52) U.S. Cl. CPC A21D 2/366; A21D 13/066; A21D 13/045; A21D 15/02; A21D 17/004; A21D 2/186; A21D 2/183; A21D 2/265

(57) ABSTRACT

A gluten-free vegetable hash-based flexible food product is described that maintains flexibility and malleability following a freeze/thaw cycle and prior to a cooking process. An example food product includes a combination of gluten-free ingredients such as gums, starches, and flours to support post-thaw flexibility and malleability after a designated thaw period while maintaining a thin shaped profile. The food product can be folded into a desired shape following the thaw period and cooked to maintain a non-planar shape and avoid leakage of fluids from moisture-containing foodstuffs held by the food product.

### CROSS-REFERENCE TO RELATED APPLICATIONS

The present application claims the benefit under 35 U.S.C. § 119(e) of U.S. Provisional Application Ser. No. 63/189,365, entitled GLUTEN-FREE FLEXIBLE VEGETABLE HASH-BASED FOOD PRODUCT, filed May 17, 2021. U.S. Provisional Application Ser. No. 63/189,365 is hereby incorporated by reference in its entirety.

### BACKGROUND

Frozen foods and associated packaging allow consumers and food preparers to store foods in a dormant state for later preparation, such as in a microwave, on a stove, or with another heat source. The frozen foods can be prepared according to a particular standard by a producer and shipped to a food preparer to provide convenient preparation options for subsequent heating or reheating of the food.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter in any manner.

Aspects of the disclosure pertain to gluten-free vegetable hash-based flexible food products that maintain flexibility and malleability following a freeze/thaw cycle and prior to a cooking process such as frying, baking, microwaving, or the like. The food product can include a combination of gluten-free ingredients such as gums, starches, and flours to support post-thaw flexibility and malleability after a designated thaw period while maintaining a thin shaped profile. The food product can be folded into a desired shape following the thaw period and cooked to maintain a non-planar shape and avoid leakage of fluids from moisture-containing foodstuffs held by the food product. The moisture-containing foodstuffs can include, for example, egg-based products (e.g., scrambled eggs), proteins (e.g., meats), vegetables (e.g., peppers, onions, etc.), sauces, condiments, and the like.

In an aspect, a method for producing a food product having malleability and flexibility following a freeze/thaw cycle includes mixing vegetable pieces, starch, flour, fat, gum, and water to form a flexible and malleable gluten-free dough, flattening the dough into a sheet to provide a flattened dough, and freezing the flattened dough to provide a frozen food product that can withstand a freeze/thaw cycle for subsequent shaping and cooking into a desired shape.

### DRAWINGS

The detailed description is described with reference to the accompanying figures.

FIG. 1 is a flow diagram illustrating a method for producing a frozen food product in accordance with example implementations of the present disclosure.

FIG. 2 is a flow diagram illustrating a method for producing a cooked food product following freezing and thawing of the food product in accordance with example implementations of the present disclosure.

FIG. 3 is an image of examples of cooked food products in accordance with example implementations of the present disclosure.

FIG. 4A is an image test formulations of food products following a cooking process.

FIG. 4B is an image cooked food products in accordance with example implementations of the present disclosure.

FIG. 5A is an image of a test formulation of a food product showing surface cracks.

FIG. 5B is an image of a test formulation of a food product that cracked when introduced to a cradle of a frying basket.

FIG. 5C is an image of a test formulation of a food product that split following a cooking process.

FIG. 6A is an image of a test formulation of a food product that maintained flexibility and malleability when introduced to a cradle of a frying basket.

FIG. 6B is an image of a test formulation of a food product that maintained structural integrity and shape during and after the cooking process.

FIG. 7A is an image of a test formulation of a food product that included guar gum and failed to properly bind ingredients during a sheeting process.

FIG. 7B is an image of a test formulation of a food product that included konjac gum and properly bound ingredients during a sheeting process.

### DETAILED DESCRIPTION

Aspects of the disclosure are described more fully hereinafter with reference to any accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. Among other things, the features of the disclosure can be embodied as formulations, food products, and processes for producing formulations and food products. The following detailed description is, therefore, not to be taken in a limiting sense.

Frozen food products are often used in the food service industry to provide convenient storage of pre-prepared or pre-cooked foods to be subsequently thawed, heated, reheated, or cooked and served to customers. A food service company can receive frozen foods products from a frozen food distributor that prepares the food products according to the particular standards desired by the food service company for convenient distribution across multiple distribution channels, restaurants, stores, and the like, while providing a consistently prepared food product at each location.

However, freezing and thawing processes can negatively affect food products. For example, the freezing process can cause certain foods to dry out during storage or transport due to moisture loss (e.g., from ice crystal formation) and can cause foods to become brittle or unmalleable upon thawing. As another example, if the food product is not thawed for a proper duration, the food product may still have ice crystals that can lead to an improperly cooked food or otherwise provide a negative consumer eating experience (e.g., if the thaw duration is too short) or the food product may lose additional moisture during the thaw process causing the food to become dry, brittle, or unmalleable (e.g., if the thaw duration is too long). Further, frozen food products may incorporate gluten-containing ingredients, however gluten can negatively affect consumers, such as those with gluten sensitivity, celiac disease, or other health conditions.

An exemplary food product includes vegetable pieces, starch, flour, fats, gums, and water formed into a flattened shape for subsequent freezing, thawing, and cooking. In an aspect, all ingredients of the food product are gluten free. For example, the starch, flour, fats, and gums can be sourced from gluten-free materials including, but not limited to, potato, rice, tapioca, and corn. Example additives can include seasoning, salt, flavorings, colorants, sweeteners, and the like. In various aspects, the food product is formed into a dough and manipulated into flattened shape through a sheeting process that maintains the dough in a substantially flexible state that permits shaping and optional cutting of the dough without substantial tearing, permitting the dough to be manipulated and cooked into various shapes.

The flattened food product maintains flexibility and malleability prior to a freezing process and following a subsequent thawing process prior to cooking, while providing a gluten-free food product. Upon shaping and cooking, the food product retains the cooked shape while maintaining structural integrity (e.g., without substantial cracking) to provide an interior region into which additional foodstuffs can be placed and held. The additional foodstuffs can include, for example, egg-based products (e.g., scrambled eggs), proteins (e.g., meats), vegetables (e.g., peppers, onions, etc.), sauces, condiments, and the like. The food product maintains the cooked shape while retaining moisture from the food product within the shape and while retaining liquids from the additional foodstuffs within the interior region formed by the food product.

Vegetable Pieces

The vegetable pieces included in the food product can be cut, sliced, diced, shaped, pulverized or otherwise reduced in size to provide pieces to be mixed with other ingredients of the food product, formed into a dough, and subsequently flattened. While certain embodiments described herein depict the vegetable as a potato, the disclosure herein shall be understood to include all vegetables and shall not be limited to potatoes. For example, the vegetables pieces can include, but are not limited to, potatoes, sweet potatoes, yams, beets, carrots, zucchinis, squash, and pumpkins. Additionally, the vegetable pieces may be substituted with or combined with a fruit including, but not limited to, apples, pears, and pineapples, that are diced, shaped, pulverized or otherwise reduced in size to provide pieces to be mixed with other ingredients of the food product, formed into a dough, and subsequently flattened.

The vegetable pieces, fruit pieces, or combinations thereof may be pre-treated to remove moisture, such as through a dehydration process. In an aspect, the vegetable pieces include potato shreds provided in a substantially dehydrated state.

In one aspect, the food product can include vegetable pieces in a weight percentage of total content of from about 9.7% to about 18.1%. As used herein, the total content of the food product excludes any additive foodstuffs introduced to the food product following shaping and cooking and any substances used in the cooking process (e.g., frying oils, baking sprays, etc.). For example, the food product can include vegetable pieces in a weight percentage of total content of from about 9.7%, 10%, 10.5%, 11%, 11.5%, 12%, 12.5%, 13%, 13.5%, 14%, 14.5%, 15%, 15.5%, 16%, 16.5%, 17%, 17.5%, 18%, 18.1% to about 9.7%, 10%, 10.5%, 11%, 11.5%, 12%, 12.5%, 13%, 13.5%, 14%, 14.5%, 15%, 15.5%, 16%, 16.5%, 17%, 17.5%, 18%, 18.1%. In one aspect, the food product can include vegetable pieces in a weight percentage of total content of from about 12.5% to about 15.3%.

In one aspect, the food product can include potato shreds in a weight percentage of total content of from about 9.7% to about 18.1%. For example, the food product can include potato shreds in a weight percentage of total content of from about 9.7%, 10%, 10.5%, 11%, 11.5%, 12%, 12.5%, 13%, 13.5%, 14%, 14.5%, 15%, 15.5%, 16%, 16.5%, 17%, 17.5%, 18%, 18.1% to about 9.7%, 10%, 10.5%, 11%, 11.5%, 12%, 12.5%, 13%, 13.5%, 14%, 14.5%, 15%, 15.5%, 16%, 16.5%, 17%, 17.5%, 18%, 18.1%. In one aspect, the food product can include dehydrated potato shreds in a weight percentage of total content of from about 12.5% to about 15.3%. The dehydrated potato shreds can have a moisture content of from about 6% to about 10% by weight of the dehydrated potato shreds. For example, the food product can include dehydrated potato shreds having a moisture content of from about 6%, 6.5%, 7%, 7.5%, 8%, 8.5%, 9%, 9.5%, 10% to about 6%, 6.5%, 7%, 7.5%, 8%, 8.5%, 9%, 9.5%, 10% by weight of the dehydrated potato shreds. In one aspect, the food product can include dehydrated potato shreds having a moisture content of from about 8% to about 9% by weight of the dehydrated potato shreds.

Starch

The food product can include starches to provide structure, flexibility, and malleability of the food product in dough form. The structure, flexibility, and malleability promote shaping of the food product in dough form without substantial tearing in freeze/thaw cycles and subsequent shaping and cooking. For example, the starch can include, but is not limited to, potato starch, tapioca starch, rice starch, corn starch, starch complexed with one or more monoglycerides, and combinations thereof. In an aspect, all of the starch in the food product is gluten-free.

In one aspect, the food product can include starch in a weight percentage of total content from about 6.9% to about 12.9%. For example, the food product can include starch in a weight percentage of total content from about 6.9%, 7%, 7.5%, 8%, 8.5%, 9%, 9.5%, 10%, 10.5%, 11%, 11.5%, 12%, 12.5%, and 12.9% to about 6.9%, 7%, 7.5%, 8%, 8.5%, 9%, 9.5%, 10%, 10.5%, 11%, 11.5%, 12%, 12.5%, and 12.9%. In one aspect, the food product can include starch in a weight percentage of total content from about 8.9% to about 10.9%.

The food product can include a combination of different gluten-free starches. For example, the food product can include a combination of two different gluten-free starches. In an aspect, the food product includes a tapioca starch in a weight percentage of total content from about 3.5% to about 6.4% and includes a potato starch in a weight percentage of total content from about 3.5% to about 6.4%. For example, the food product can include a tapioca starch in a weight percentage of total content from about 4.5% to about 5.4% and includes a potato starch with monoglycerides in a weight percentage of total content from about 4.5% to about 5.4%.

Flour

The food product can include flour to provide structure, flexibility, and malleability of the food product in dough form. The structure, flexibility, and malleability promote sheeting of the food product in dough form without substantial tearing in freeze/thaw cycles and subsequent shaping and cooking. For example, the flour can include, but is not limited to, potato flour, tapioca flour, rice flour, corn flour, and combinations thereof. In an aspect, all of the flour in the food product is gluten-free.

In one aspect, the food product can include flour in a weight percentage of total content from about 6.2% to about 9.7%. For example, the food product can include flour in a weight percentage of total content from about 6.2%, 6.5%, 7%, 7.5%, 8%, 8.5%, 9%, 9.5%, and 9.7% to about 6.2%, 6.5%, 7%, 7.5%, 8%, 8.5%, 9%, 9.5%, and 9.7%. In one aspect, the food product can include flour in a weight percentage of total content from about 6.7% to about 8.2%.

The food product can include a combination of different gluten-free flours or flour components. For example, the food product can include a combination of two, three, or more different gluten-free flours or flour components. In an aspect, the food product includes a combination of three gluten-free flours including a rice and tapioca flour blend in a weight percentage of total content from about 2.1% to about 3.9%, a glutinous rice flour in a weight percentage of total content from about 1.9% to about 3.4%, and a potato flour in a weight percentage of total content from about 1.3% to about 2.4%. For example, the food product can include a rice and tapioca flour blend in a weight percentage of total content from about 2.7% to about 3.3%, a glutinous rice flour in a weight percentage of total content from about 2.4% to about 2.9%, and a potato flour in a weight percentage of total content from about 1.7% to about 2.0%.

Fats

The food product can include one or more fats to provide structure, flexibility, and malleability of the food product in dough form and provide flavor and texture to the food product upon cooking. For example, the fats can include, but are not limited to, room temperature solid fats, room temperature liquid fats, saturated fats, unsaturated fats, polyunsaturated fats, and combinations thereof. In an aspect, all of the fats in the food product are gluten-free.

In one aspect, the food product can include fats in a weight percentage of total content from about 3.2% to about 5.9%. For example, the food product can include fats in a weight percentage of total content from about 3.2%, 3.5%, 4%, 4.5%, 5%, 5.5%, and 5.9% to about 3.2%, 3.5%, 4%, 4.5%, 5%, 5.5%, and 5.9%. In one aspect, the food product can include fats in a weight percentage of total content from about 4.1% to about 5%.

The food product can include a combination of different fats. For example, the food product can include a combination of two, three, or more different fats, such as solid fats and liquid fats. In an aspect, the food product includes a combination of fats including shortening in a weight percentage of total content from about 1.6% to about 3.0% and a liquid fat in a weight percentage of total content from about 1.5% to about 2.9%. For example, the food product can include shortening in a weight percentage of total content from about 2.1% to about 2.6% and a liquid fat in a weight percentage of total content from about 2.0% to about 2.4%. The liquid fat can include, but is not limited to, olive oil, soybean oil, sunflower oil, canola oil, corn oil, rapeseed oil, palm oil, palm kernel oil, and combinations thereof. For example, in an aspect, the food product can include canola oil in a weight percentage of total content from about 2.0% to about 2.4%.

Gums

The food product can include one or more gums to provide structure, flexibility, and malleability of the food product in dough form and upon cooking. In an aspect, the gums promote moisture retention of the food product during a thaw process to avoid significant water loss that could otherwise contribute to a dry and brittle structure for the food product. The gums promote shaping of the food product in dough form without substantial tearing in freeze/thaw cycles and subsequent shaping and cooking. For example, the gums can include, but are not limited to, xanthan gum, konjac gum, locust bean gum, cellulose gum, gum additives (e.g., inulin, maltodextrin, carrageenan, etc.), and combinations thereof. In an aspect, all of the gums in the food product are gluten-free.

In one aspect, the food product can include gums in a weight percentage of total content from about 1.0% to about 1.9%. For example, the food product can include gums in a weight percentage of total content from about 1.0%, 1.2%, 1.3%, 1.4%, 1.5%, 1.6%, 1.7%, 1.8%, and 1.9% to about 1.0%, 1.2%, 1.3%, 1.4%, 1.5%, 1.6%, 1.7%, 1.8%, and 1.9%. In one aspect, the food product can include gums in a weight percentage of total content from about 1.3% to about 1.6%. For example, the food product can include xanthan gum in a weight percentage of total content from about 1.3% to about 1.6%.

Water

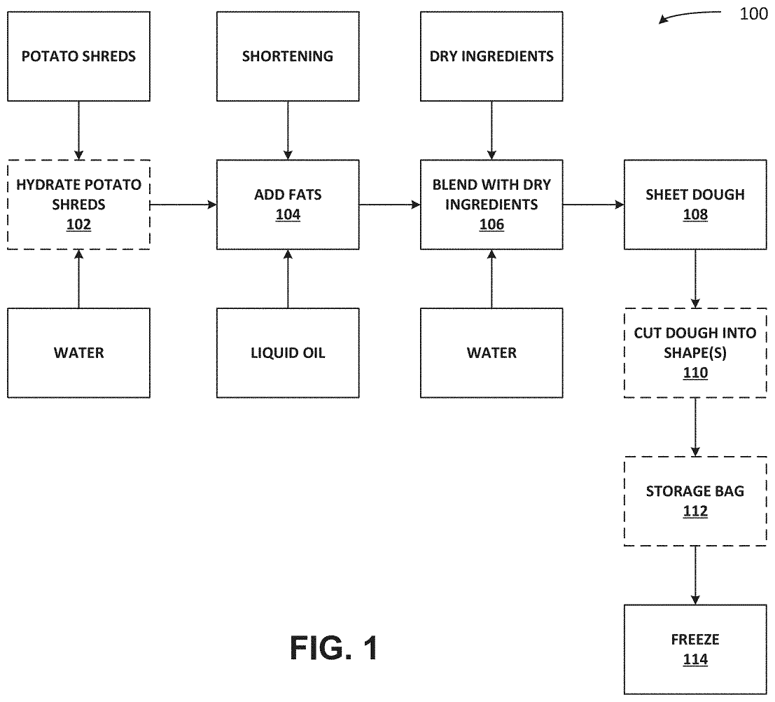

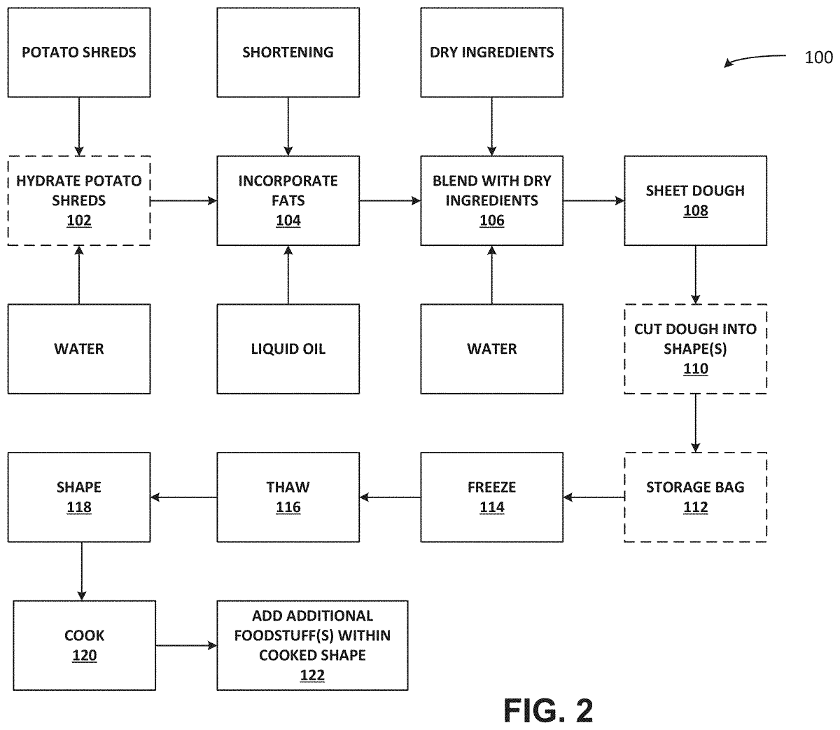

The food product can include water to blend the dry and liquid ingredients and form the food product into a dough prior to cooking while maintaining structure, flexibility, and malleability of the food product in dough form. The water can be included to the food product in one or more steps and in one or more temperatures to facilitate mixing of the ingredients. For example, the water can be added in a first step at an elevated temperature and in a second step at a cooler temperature (e.g., as described with reference to FIGS. 1 and 2).

In one aspect, the food product can include water in a weight percentage of total content from about 41.8% to about 77.7%. For example, the food product can include water in a weight percentage of total content from about 41.8%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, and 77.7% to about 41.8%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, and 77.7%. In one aspect, the food product can include water in a weight percentage of total content from about 53.8% to about 65.7%.

In an aspect, the food product includes water added to the food product in a plurality of steps to facilitate mixing of the ingredients. For example, the food product can include addition of hot water (e.g., from about 130° F. to about 170° F.) in a weight percentage of total content from about 29.5% to about 54.7% in a first step and can include addition of cold water in a weight percentage of total content from about 12.4% to about 23.0% in a second step. For example, the food product can include addition of hot water in a weight percentage of total content from about 37.9% to about 46.3% in a first step and can include addition of cold water in a weight percentage of total content from about 15.9% to about 19.4% in a second step.

Additives

The food product can include one or more additives to provide or enhance one or more characteristics of the food product, such as flavor, texture, color, and the like. For example, the food product can include one or more seasonings, salts, flavorings, colorants, sweeteners, and the like, and combinations thereof.

In one aspect, the food product can include additives in a weight percentage of total content from about 2.1% to about 3.8%. For example, the food product can include additives in a weight percentage of total content from about 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, and 3.8% to about 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, and 3.8%. In one aspect, the food product can include additives in a weight percentage of total content from about 2.7% to about 3.2%.

In one aspect, the food product can include a natural or artificial flavorant in a weight percentage of total content from about 0.7% to about 1.3%. For example, the food product can include a natural or artificial flavorant in a weight percentage of total content from about 0.9% to about 1.1%. In one aspect, the natural or artificial flavorant can include a natural powder of fried potato type flavor in a weight percentage of total content from about 0.7% to about 1.3%. For example, the food product can include a natural powder of fried potato type flavor in a weight percentage of total content from about 0.9% to about 1.1%.

In one aspect, the food product can include a seasoning or seasoning blend in a weight percentage of total content from about 0.66% to about 1.22%. For example, the food product can include a seasoning or seasoning blend in a weight percentage of total content from about 0.85% to about 1.03%. In one aspect, the natural or artificial flavorant can include a hash brown seasoning in a weight percentage of total content from about 0.66% to about 1.22%. For example, the food product can include a hash brown seasoning in a weight percentage of total content from about 0.85% to about 1.03%.

In one aspect, the food product can include a salt or a salt blend in a weight percentage of total content from about 0.54% to about 1.00%. For example, the food product can include a salt or a salt blend in a weight percentage of total content from about 0.69% to about 0.85%. The salt can include various types (e.g., sea salt, kosher salt, rock salt, and the like) and sizes (e.g., finely ground salt, flour-cut salt, pulverized salt, and the like) of salts.

In one aspect, the food product can include a sweetener or a sweetener blend in a weight percentage of total content from about 0.15% to about 0.29%. For example, the food product can include a sweetener or a sweetener blend in a weight percentage of total content from about 0.20% to about 0.24%. The sweetener can include a liquid sweetener, a granulated sweetener, and combinations thereof, and can include, but is not limited to, white sugar, brown sugar, dextrose, corn syrup, sugar alcohol, and combinations thereof. In one aspect, the sweetener or a sweetener blend can include dextrose in a weight percentage of total content from about 0.15% to about 0.29%. For example, the food product can include dextrose in a weight percentage of total content from about 0.20% to about 0.24%.

In one aspect, the food product can include a colorant or a colorant blend in a weight percentage of total content from about 0.01% to about 0.03%. For example, the food product can include a colorant or a colorant blend in a weight percentage of total content of about 0.02%. The colorant can include, but is not limited to, turmeric, paprika, annatto, caramel, and combinations thereof. In one aspect, the colorant can include a blend of turmeric and annatto in a weight percentage of total content from about 0.01% to about 0.03%. For example, the food product can include a blend of turmeric and annatto in a weight percentage of total content of about 0.02%.

Example Frozen Product Production

Referring to FIGS. 1-2, a process 100 for producing an example food product is shown. The process 100 begins with an optional step of rehydrating potato shreds in operation 102. For example, when the food product includes dehydrated potato shreds as the vegetable pieces, rehydration of the potato shreds can enhance mixing of the potato shreds in subsequent steps of dough formation. In an aspect, potato shreds in a weight percentage of total content of from about 9.7% to about 18.1% and hot water (e.g., from about 130° F. to about 170° F.) in a weight percentage of total content from about 29.5% to about 54.7% are added to a mixer. The mixer can be operated to mix for a time period and to rest for a time period according to a number of cycles and according to a variety of mixing speeds. In an aspect, the mixer can mix the hot water and the dehydrated potato shreds for a first time period (e.g., from about 20 to about 40 seconds) at a low speed and then permit the mixture to rest for a second time (e.g., from about 2 to about 4 minutes) for a single cycle and then repeat the cycle multiple times.

The process 100 includes operation 104 where the fats are added to the rehydrated potato shreds. In an aspect, shortening in a weight percentage of total content from about 1.6% to about 3.0% and a liquid fat in a weight percentage of total content from about 1.5% to about 2.9% are added to the mixer and mixed with the rehydrated potato shreds. In an aspect, the fats are mixed with the rehydrated potato shreds for a duration from about 1 to about 3 minutes at a low speed. The process 100 also includes operation 106 where the remainder of the food product ingredients are introduced. For example, the remaining dry ingredients of the food product and cold water can be introduced to the mixture to mix with the fats and rehydrated potato shreds to produce a dough. The mixing process of operation 106 can include multiple mixing steps. For example, operation 106 can include a first mixing step where the remaining dry ingredients of the food product are first introduced to the mixer to mix with the fats and rehydrated potato shreds for a first duration (e.g., from about 0.5 minutes to about 1.5 minutes). The operation 106 can then include a second mixing step where a first portion (e.g., about one-half) of the cold water is added to the mixer to mix for a second duration (e.g., from about 0.5 minutes to about 1.5 minutes) followed by a third mixing step where the remainder of the cold water is added to the mixer to mix for a third duration (e.g., from about 0.5 minutes to about 1.5 minutes). The mixed dough can then be permitted to rest prior to any additional mixing and resting steps.

The process 100 also includes operation 108 where the dough is flattened into sheets to prepare the dough for freezing. In one aspect, sheeting equipment can flatten the dough into sheets having a thickness from about 0.12 inches to about 0.20 inches. For example, the sheeting equipment can flatten the dough into sheets having a thickness from about 0.15 inches to about 0.17 inches. Following the sheeting process, the process can proceed to an optional shaping process in operation 110. For example, the sheeted dough can be cut into shapes. In one aspect, the sheeted dough is cut into circles having a diameter from about 3 inches to about 7 inches. The shaped dough can facilitate shaped cooked food products of the present disclosure to create an interior volume into which additional foodstuffs can be placed and consumed along with the shaped cooked food products. For example, the shaped dough can be formed into non-planar shapes (e.g., through usage of a cradle or other forming device during a frying or cooking operation) where an interior of the non-planar shape can hold the additional foodstuffs. The additional foodstuffs can include, but are not limited to, egg-based products (e.g., scrambled eggs), proteins (e.g., meats), vegetables (e.g., peppers, onions, etc.), sauces, condiments, and the like.

The process 100 can also include an optional packaging process in operation 112. For example, the sheeted dough (and optionally shaped dough) can be individually or bulk packaged into freezer bags or containers. The food product maintains flexibility and malleability during operations 108, 110, and 112 prior to freezing. The process 100 then proceeds to operation 114, where the dough products are chilled to a substantially frozen state. Alternatively or additionally, portions of the dough products can be frozen, cooled, or partially frozen prior to introduction to storage bags. As used herein, the term “frozen state” refers to the state of foodstuffs having been subjected to chilled temperatures for a duration sufficient to preserve the foodstuff from spoilage by freezing water contained therein and can include, for example, foodstuffs having a temperature below about 0° F. In one aspect, the freezing process subjects the food products to a temperature of about −9° F. for a duration of about 24 hours. Following freezing, the food product can be stored to transported (e.g., to a food service provider or distributor).

Referring to FIG. 2, the process 100 includes steps to prepare the dough for consumption following the freezing process in operation 114. For example, the process 100 can proceed to operation 116 where the frozen food product is permitted to thaw. In one aspect, the frozen food product is thawed under refrigerated conditions (e.g., about 48° F.). The duration of thawing was determined to be an important factor in the ability of the food product to maintain flexibility and malleability prior to cooking. Thawing durations of about 24 hours and higher promoted the development of a dried appearance in the food product and an increase in breakage of the dough during subsequent shaping steps (e.g., operation 118 described herein). Thawing durations of less than about 10 hours did not allow for a full melt of ice crystals present in the food product following freezing in operation 114.

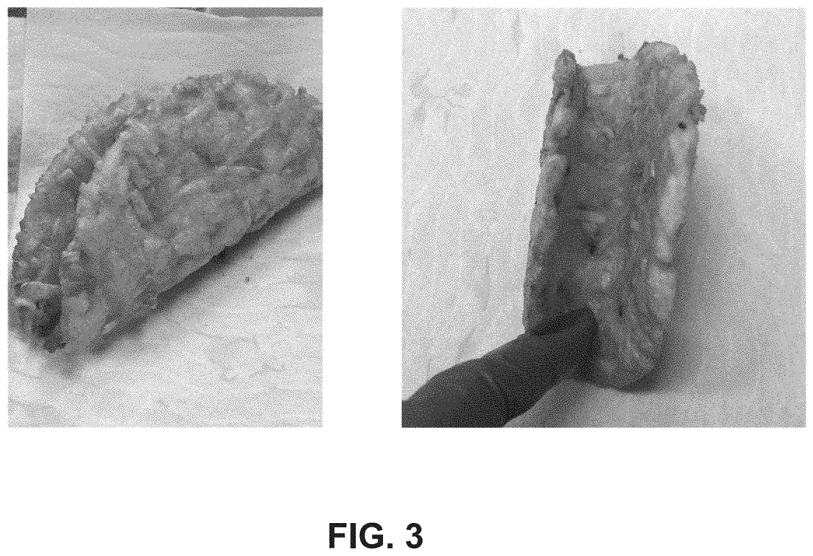

Following thawing, the process 100 also includes operations 118 and 120, where the thawed dough is shaped and cooked, respectively. In one aspect, the thawed dough is shaped by placing the thawed dough into a cradle formed by a frying basket and then fried in hot oil to cook the dough into the shape formed in the cradle. For example, the thawed dough can form a non-planar shape, including but not limited to, a shell shape (e.g., a characteristic taco shell shape), in the cradle of a frying basket and cooked at a temperature of about 350° F. for about 1.5 minutes. An example of the cooked food product is shown in FIG. 3, where the food product presents a characteristic taco shell shape while providing a hash brown texture and having visible potato shreds in the shell. The process 100 can also include introduction of additional foodstuffs in operation 122 to provide a consumer product for consumption. For example, the additional foodstuffs can include, for example, egg-based products (e.g., scrambled eggs), proteins (e.g., meats), vegetables (e.g., peppers, onions, etc.), sauces, condiments, and the like, placed into an interior of the food product formed during the shaping and cooking process (e.g., into the taco-shell shape).

Example Development Research

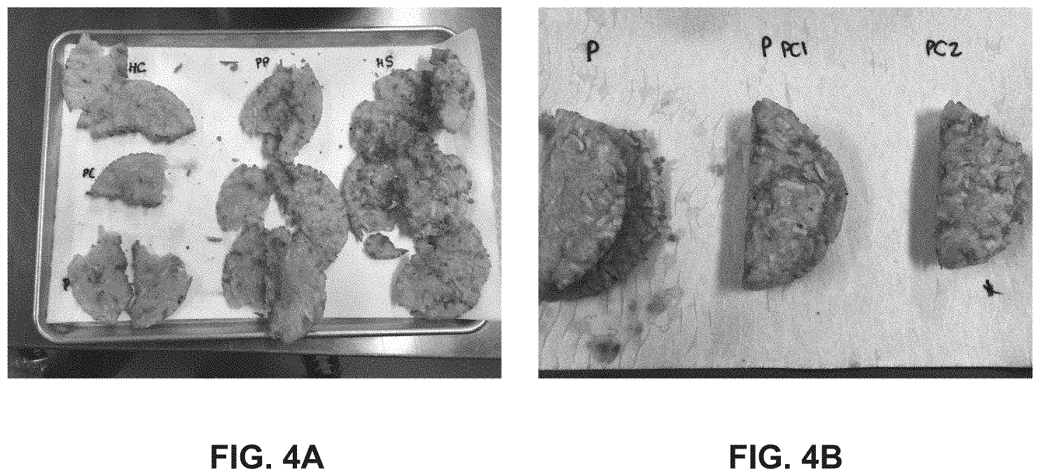

Incorporation of different types of starches and flours was evaluated at multiple stages of the development process of the food products described herein. In an example study, food products including the following ingredients were evaluated: pregelatinized corn starch from waxy maize (e.g., to develop a crispy texture), pregelatinized unmodified potato starch (e.g., to improve rollability and prevent cracking), pregelatinized potato starch from waxy potato (e.g., to help to bind the ingredients), and multifunctional rice flour (e.g., to provide stability during cold storage). All ingredients were tested in different concentrations to achieve the desired conditions in the final fried product. For example, FIG. 4A shows evaluation of initial concentrations of ingredients and FIG. 4B shows evaluation of example final formulations.

A study on the effect of pre-cooking the dough prior to freezing was conducted to review the effect of heat on the degradation of starch and increase the resistance of the dough during the placement in the frying basket. A countertop gas griddle was used at 350° F. and the food product was tested for 1 and 2 min (half time on each side) and compared with samples without pre-cooking. Although the pre-cooked products showed better resistance to breakage, it was not possible to fold it to place the pre-cooked products in the frying basket without subsequent fracture.

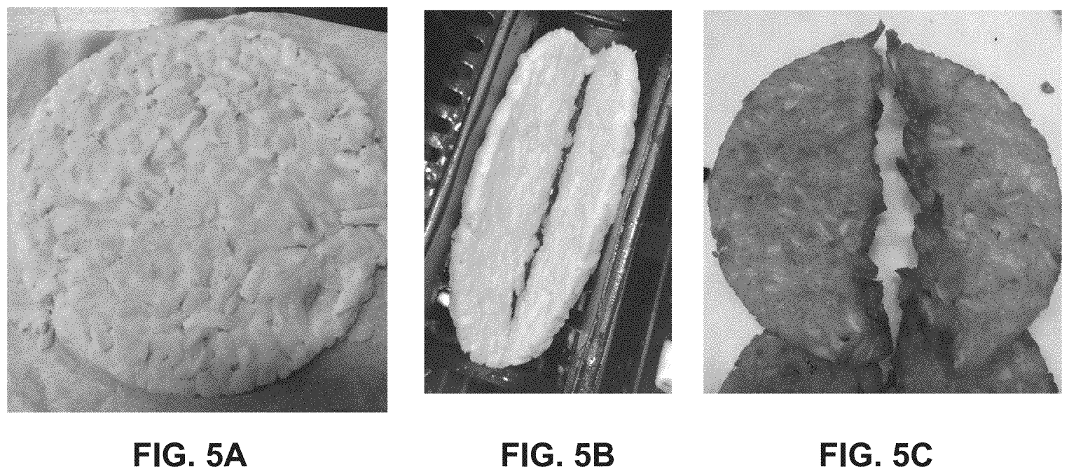

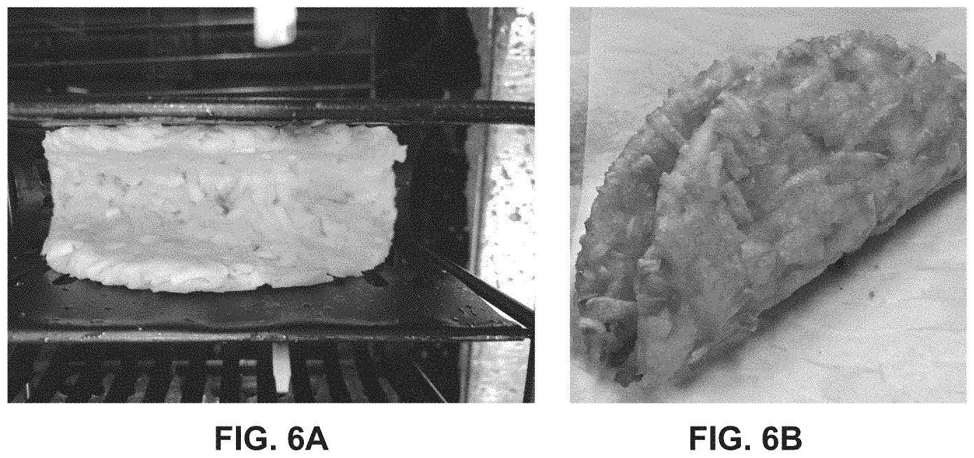

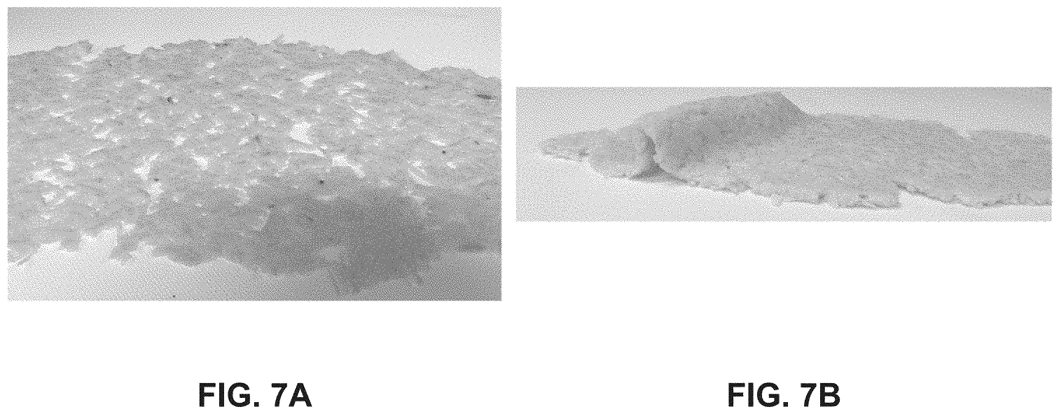

A study on the effect of inclusion of gums into the food product were conducted. It was noted that after the freezing and thawing processes, many test formulations lacked moisture that was causing cracking on the surface and eventually promoting breaking during the placement of the food product into the fryer basket and after frying (examples shown in FIGS. 5A, 5B, and 5C). Gums were then introduced into test formulations to determine the effects on elasticity after thawing. Results after the incorporation of the gum were positive and the test products were able to keep a circular shape without breaking before and after frying (examples as shown in FIGS. 6A and 6B). Furthermore, the test products presented a more hydrated surface after thawing. However, not all gums presented sheetability of the test formulations. In one test, guar gum has a poor binding effect between the ingredients and was not able to form a sheet (example shown in FIG. 7A), whereas other gums, such as the example formulation made with konjac gum shown in FIG. 7B, improved the malleability of the dough during sheeting in the sheeting machine.

A study on the effects of introduction of additional foodstuffs to a cooked food product described herein was performed. Empty cooked shells having a characteristic taco shell shape were left under a heat lamp for durations of 15 minutes, 30 minutes, and 60 minutes to evaluate changes in texture. No visible changes were detected. Afterward, new cooked food products were filled with fresh and warm scrambled eggs and ham and cold hot sauce was added on top of the added foods. The food product was evaluated under a heat lamp and without a heat lamp. After 30 minutes, 60 minutes, and 120 minutes, the shell presented the same texture, and there was no migration from moisture released by the additional foodstuffs. No leaking was observed in any of the tested conditions.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A food product having malleability and flexibility following a freeze/thaw cycle, the food product comprising:
a dough including vegetable pieces, starch, flour, fat, gum, and water in a flexible and malleable flat shape, wherein the food product is gluten-free, wherein the dough includes
vegetable pieces in a weight percentage of the dough of from about 9.7% to about 18.1%;
starch in a weight percentage of the dough from about 6.9% to about 12.9%;
flour in a weight percentage of the dough from about 6.2% to about 9.7%;
fat in a weight percentage of the dough from about 3.2% to about 5.9%;
gum in a weight percentage of the dough from about 1.0% to about 1.9%; and
water in a weight percentage of the dough from about 41.8% to about 77.7%.

2. The food product of claim 1, wherein the vegetable pieces include potato shreds.

3. The food product of claim 2, wherein the potato shreds are dehydrated potato shreds having a moisture content from about 6% to about 10% by weight of the dehydrated potato shreds.

4. The food product of claim 1, wherein the flexible and malleable flat shape of the dough includes a thickness from about 0.12 inches to about 0.20 inches.

5. The food product of claim 1, wherein the fat is included as a combination of shortening and a liquid fat, wherein the shortening is included in a weight percentage of the dough from about 1.6% to about 3.0% and the liquid fat is included in a weight percentage of the dough from about 1.5% to about 2.9%.

6. The food product of claim 5, wherein the liquid fat includes at least one of olive oil, soybean oil, sunflower oil, canola oil, corn oil, rapeseed oil, palm oil, palm kernel oil.

7. The food product of claim 1, wherein the dough includes starch as a combination of starches including at least a tapioca starch and a potato starch.

8. The food product of claim 7, wherein the dough includes tapioca starch in a weight percentage of the dough from about 3.5% to about 6.4% and includes potato starch in a weight percentage of the dough from about 3.5% to about 6.4%.

9. The food product of claim 1, wherein the dough includes flour as a combination of flours including at least a rice flour, a tapioca flour, and a potato flour.

10. The food product of claim 1, wherein the gum includes at least one of xanthan gum and konjac gum.

11. The food product of claim 1, further comprising an additive including one or more of a seasoning, a salt, a flavor additive, a colorant, or a sweetener, wherein the additive is included in a weight percentage of the dough from about 2.1% to about 3.8%.

12. A method for producing a food product having malleability and flexibility following a freeze/thaw cycle, the method comprising:
mixing vegetable pieces, starch, flour, fat, gum, and water to form a flexible and malleable dough, wherein the dough is gluten-free;
flattening the dough into a sheet to provide a flattened dough, the flattened dough including
vegetable pieces in a weight percentage of the flattened dough of from about 9.7% to about 18.1%,
starch in a weight percentage of the flattened dough from about 6.9% to about 12.9%,
flour in a weight percentage of the flattened dough from about 6.2% to about 9.7%,
fat in a weight percentage of the flattened dough from about 3.2% to about 5.9%,
gum in a weight percentage of the flattened dough from about 1.0% to about 1.9%, and
water in a weight percentage of the flattened dough from about 41.8% to about 77.7%; and
freezing the flattened dough to provide a frozen food product.

13. The method of claim 12, further comprising thawing the frozen food product to provide a thawed food product.

14. The method of claim 13, wherein thawing the frozen food product to provide a thawed food product includes thawing the frozen food product under refrigerated conditions for a duration from about 10 hours to about 24 hours.

15. The method of claim 13, further comprising shaping the thawed food product into a non-planar shape.

16. The method of claim 15, further comprising cooking the thawed food product while the thawed food product is in the non-planar shape to provide a cooked, shaped food product.

17. The method of claim 16, further comprising introducing one or more additional foodstuffs into an interior formed by the cooked, shaped food product.

18. A method for producing a food product having malleability and flexibility following a freeze/thaw cycle, the method comprising:
mixing potato shreds, water, and fats in a first mix operation to provide a first mixture;
mixing the first mixture with starch, flour, fat, gum, and water in a second mixt operation to form a flexible and malleable dough, wherein the dough is gluten-free;
flattening the dough into a sheet to provide a flattened dough, the flattened dough including
vegetable pieces in a weight percentage of the flattened dough of from about 9.7% to about 18.1%,
starch in a weight percentage of the flattened dough from about 6.9% to about 12.9%,
flour in a weight percentage of the flattened dough from about 6.2% to about 9.7%,
fat in a weight percentage of the flattened dough from about 3.2% to about 5.9%,
gum in a weight percentage of the flattened dough from about 1.0% to about 1.9%, and
water in a weight percentage of the flattened dough from about 41.8% to about 77.7%; and
freezing the flattened dough to provide a frozen food product.

19. The method of claim 18, wherein mixing potato shreds, water, and fats in a first mix operation to provide a first mixture includes rehydrating dehydrated potato shreds with water to provide rehydrated potato shreds and mixing the rehydrated potato shreds with fats to provide the first mixture.

20. The method of claim 18, wherein flattening the dough into a sheet to provide a flattened dough includes flattening the dough into sheets having a thickness from about 0.12 inches to about 0.20 inches.
